(19) United States
(12) Patent Application Publication
(10) Pub. No.: US 2012/0130603 A1
(43) Pub. Date: May 24, 2012

(54) SYSTEM AND METHOD FOR CONTROLLING A TRANSMISSION OF A HUMAN-POWERED VEHICLE

(76) Inventors: Sean Michael Simpson, Troy, MI (US); Mark Wayne Simpson, Warren, MI (US); John Richard Czoykowski, Grosse Pointe Park, MI (US)

(21) Appl. No.: 13/297,804

(22) Filed: Nov. 16, 2011

Related U.S. Application Data
(60) Provisional application No. 61/415,253, filed on Nov. 18, 2010.

(51) Int. Cl. G06F 17/00

(52) U.S. Cl. 701/51

(57) ABSTRACT

This system creates a virtual image of the user's entire operating environment using a combination of hub speed, crank speed, inclination, and acceleration measurements. With this information, the system is able to understand the output torque and speed, and through control of the transmission, change the “gear ratio” to achieve a more desired operating condition based on the individual user's preferences. In addition, this system is designed to also work with a continuously variable transmission to avoid the shortfall of the state of the art systems, which can only get within a wide range of the optimal cadence because of the fixed ratios of a derailleur system.

### RELATED APPLICATION

The present application claims priority to U.S. Provisional Patent Application 61/415,253 filed on Nov. 18, 2010, which is hereby incorporated by referenced.

### FIELD OF THE INVENTION

The present invention relates generally to human-powered vehicles, and more particularly, to a system and method for controlling the transmission of a human-powered vehicle as a function of estimated user effort.

### BACKGROUND OF THE INVENTION

The present invention is a control system for human-powered vehicles that uses key sensor information to understand the user's current conditions and adjust any number of transmissions, including derailleur, internally geared hub, and continuously variable types, to the most optimum “gear ratio” available.

There are several known examples of automatic shifting systems designed for human-powered vehicles. Using rear hub speed and/or crank speed, these systems use a simple algorithm to determine what gear the transmission should be in, and then based on what transmission ratios are actually available, shift to that gear. There are many shortfalls to a system that does not fully comprehend the environment in which the user is operating. Also, they possess the additional limitations of the fixed gear transmission that is a part of those systems. For example, the state of the art control systems would choose the same ratio if a person was climbing a 10% incline or on level ground, despite the level of effort being more than ten times greater. As long as the user's pedal speed and rear hub speed were the same, those control systems would not be capable of discerning the difference. The system that does not take into account external factors directly would force the user to slow down before it would calculate a new gear ratio and then would still need to shift into a gear that will be, at best, an approximation of the optimum ratio because of the finite number of fixed ratios available. Also, the ratio change itself would cause the user to feel an unwanted jerk that is oftentimes accompanied by an unpleasant sound. A system that takes into account these external factors would determine that the user was on an incline before they had to drastically increase their effort, and if combined with an unlimited number of gear ratios, the system could place the user into the optimal gear, directly leading to a more comfortable, smooth riding experience.

The present invention is directed to one or more of the problems identified above.

### SUMMARY OF THE INVENTION

In one aspect of the present invention, a system for controlling a transmission of a human-powered vehicle is provided. The vehicle has an axle and a transmission with a plurality of gear ratios for transmitting force applied by a user to the axle. The system includes a sensing device and a controller. The sensing device measuring at least one parameter of the vehicle and generates a sensor signal. The controller receives the sensor signal, responsively establishes an estimate of user effort as a function of the sensor signal, responsively establishes a desired gear ratio as a function of the estimate of the user effort, and sends a desired gear ratio signal to the transmission as a function of the established desired gear ratio.

In another aspect of the present invention, a method for controlling a transmission of a human-powered vehicle is provided. The vehicle has an axle and a transmission with a plurality of gear ratios for transmitting force applied by a user to the axle. The method includes the steps of measuring at least one parameter of the vehicle and generating a first signal, and through the use of a controller, receiving the sensor signal, responsively establishing an estimate of user effort as a function of the sensor signal, responsively establishing a desired gear ratio as a function of the estimate of the user effort, and sending a desired gear ratio signal to the transmission as a function of the established desired gear ratio.

In still another aspect of the present invention, a control system that can automatically shift a number of different styles of human-powered vehicle transmissions is provided. Regardless of the transmission, the control system uses a specific set of sensors that collectively define the user's exact riding condition (speed, torque, and inclination) and then determines an optimum gear ratio based on the available ratios of the transmission. The group of sensors required to determine user effort can vary based on the packaging constraints of the system. The shift mechanism is an electric motor, typically with a transmission designed to reduce speed and increase torque, which is sized based on the needs of the particular human-powered vehicle transmission. The electric motor is attached to an adapter that mimics the manual shifter interface for the given transmission. For a step ratio transmission, the system is calibrated to provide the discrete same cable length change as the manual shifter would provide, only faster and more positively. For continuously variable transmissions, the motor is calibrated to provide any ratio between the minimum and maximum ratios of the transmission. The bi-directional electric motor is connected to the controller which provides the control signals based on an algorithm that calculates torques and speeds and determines the optimal gear based on the available ratios. The controller functions on fixed voltage which is supplied by a power system. In this example, that power system is a battery that is recharged using a front hub dynamo, typically 6V due to availability and ergonomic constraints.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1A is a diagram of a computer-controlled shifting system, according to a first embodiment of the present invention;

FIG. 1B is a diagram of a computer-controlled shifting system, according to a second embodiment of the present invention;

FIG. 1C is a diagram of a computer-controlled shifting system, according to a third embodiment of the present invention;

FIG. 1D is a diagram of a computer-controlled shifting system, according to a fourth embodiment of the present invention;

FIG. 2A is a visual representation of how inclination is derived from absolute acceleration and a calculated rate of acceleration;

FIG. 2B is a flow diagram of a method for automatically controlling a transmission of a human-powered vehicle, according to an embodiment of the present invention;

FIG. 3 shows how the sensor output and calculated rate of acceleration can be used to determine inclination;

FIG. 4 shows one of the potential mathematical relationships between desired pedal speed and power, according to an embodiment of the present invention;

FIG. 5 is a side view of a bicycle that incorporates an automatic shifting system, according to an embodiment of the present invention;

FIG. 6 is a front view of a speed sensing configuration where magnetic pickups are mounted to a rotating element with a fixed sensing element mounted planar to the direction of rotation;

FIG. 7 is a side view of a speed sensing configuration where magnetic pickups are mounted to a rotating element with a fixed sensing element being mounted perpendicular to the direction of rotation.

FIG. 8 is a front view of a speed sensing configuration where a magnetic material has a plurality of teeth machined into it with a fixed sensing element mounted planar to the direction of rotation.

FIG. 9 is a front and side view of a speed sensing configuration where a magnetic material has cutouts with a fixed sensing element mounted perpendicular to the direction of rotation.

### DETAILED DESCRIPTION OF THE PREFERRED EMBODIMENT

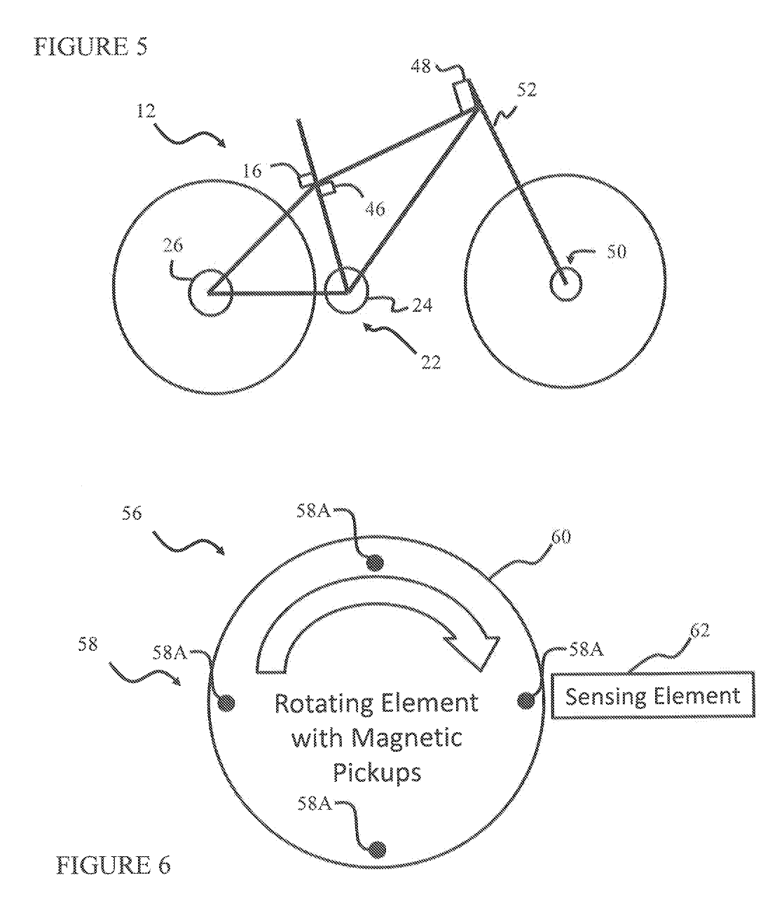

With reference to the drawings and in operation, the present invention provides a system 10 and method 40 for controlling a transmission 20 of a human-powered vehicle 12 such as a bicycle (see FIG. 5). The system 10 and method includes a sensing device 14 and a controller 16.

The sensing device 14 measures a parameter of the vehicle 12 and responsively generates a sensor signal.

The controller 16 receives the sensor signal, responsively establishes an estimate of user effort as a function of the sensor signal, responsively establishes a desired gear ratio as a function of the estimate of the user effort, and sends a desired gear ratio signal to the transmission as a function of the established desired gear ratio.

The present invention is aimed at matching a user's effort level with an optimum gear ratio. In one embodiment of the present invention, the user's effort level, or output power is measured indirectly. In another embodiment of the present invention, the user's effort level, or output power is measured, at least in part, directly.

In one embodiment, the sensing device 14 includes an accelerometer 18 for measuring an acceleration associated with the vehicle 12. The controller 16 determines an inclination of the vehicle 12 as a function measured acceleration.

In one embodiment, the sensing device 14 also includes a gear ratio detector 22 for detecting a current gear ratio of the transmission 20 and generating a current gear ratio signal. The gear ratio detector 22 includes a rotary encoder 23 coupled to the transmission 20.

In another embodiment, the sensing device 12 includes a pedal speed sensor 24 and a rear hub speed sensor 26. The pedal speed sensor 24 is coupled to a crank set 28 of the bicycle 12 for sensing a pedal speed and responsively generating a pedal speed signal. The rear hub speed sensor 26 is coupled to the axle 30 for sensing a rear hub axle speed and responsively generating a rear hub axle speed signal. The controller 16 receives the pedal speed signal and the rear hub axle speed signal and responsively determines a current gear ratio signal. The controller 16 establishes the desired gear ratio as a function of the inclination of the vehicle and the current gear ratio signal.

In a second embodiment of the present invention, the sensing device 14 includes a pedal force sensor 32 coupled to the crank set 28 of the vehicle 12 for measuring a force applied to the crank set 28 by the user and responsively generating a pedal force signal.

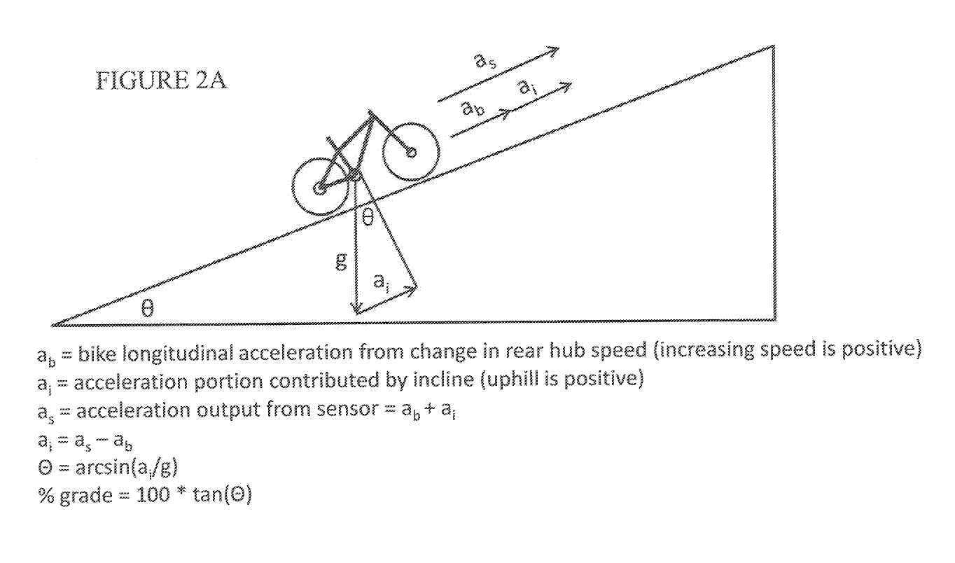

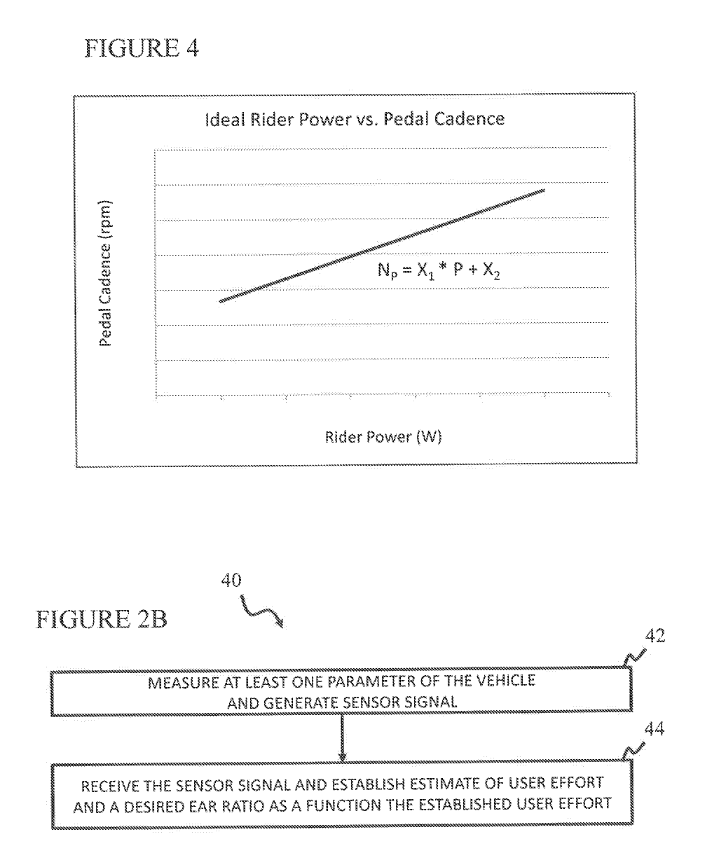

In another aspect of the present invention, a method 40 (FIG. 2B) for controlling a transmission 20 of a human-powered vehicle 12 is provided. The vehicle 12 has an axle 30 and a transmission 20 with a plurality of gear ratios for transmitting force applied by a user to the axle 30. In a first step 42 at least one parameter of the vehicle is measured and a first signal is generated. In a second step 44, a controller 16 receives the sensor signal, responsively establishes an estimate of user effort as a function of the sensor signal, responsively establishes a desired gear ratio as a function of the estimate of the user effort, and sends a desired gear ratio signal to the transmission as a function of the established desired gear ratio.

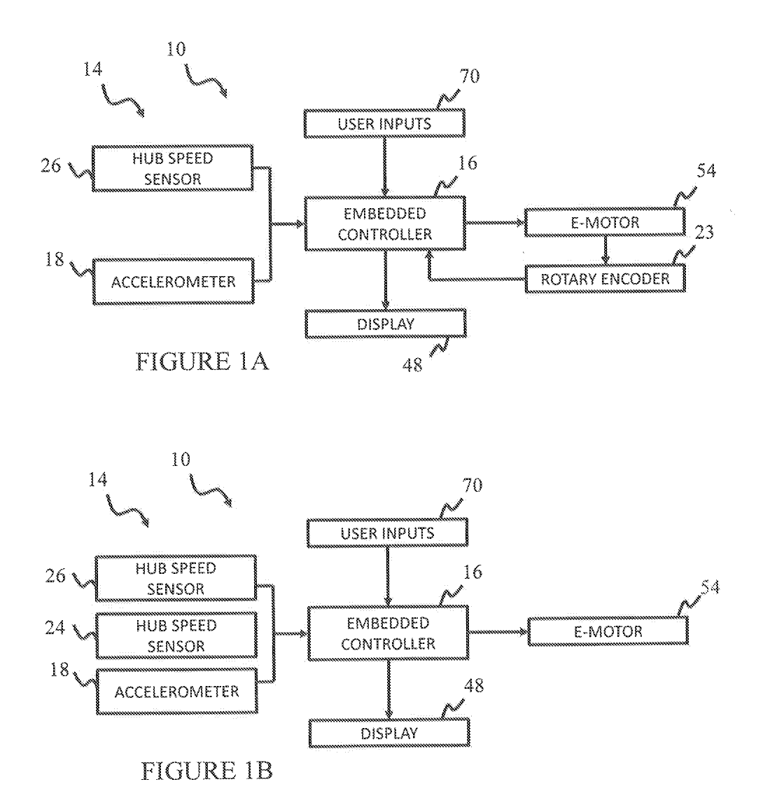

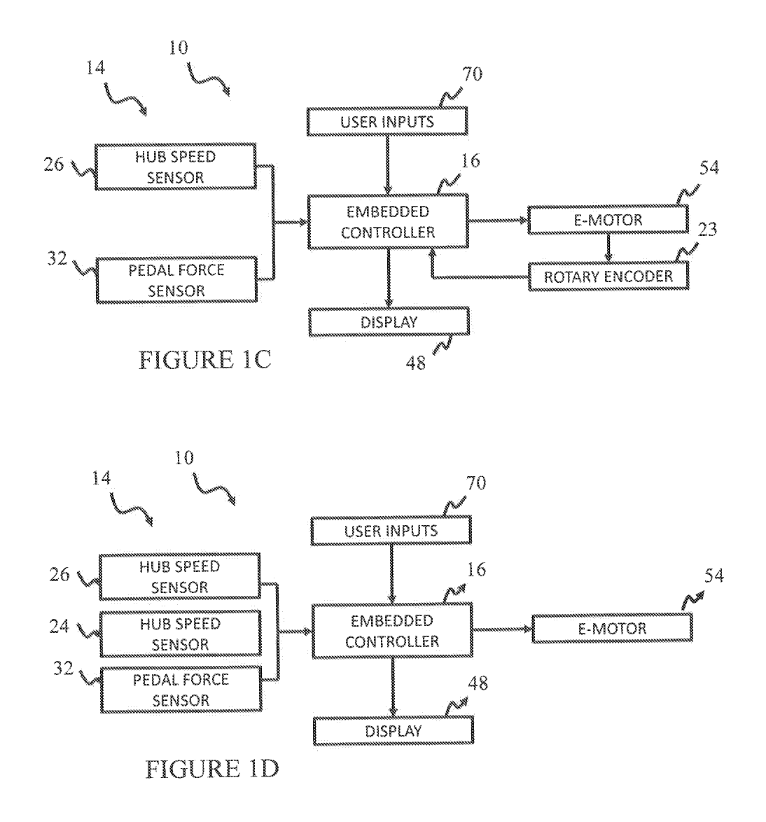

FIGS. 1A-1D, each represent an embodiment of the computer-controlled shifting system 10 and method 40 which are designed to match a user's effort level with an optimum gear ratio.

The embodiment in FIG. 1A uses the accelerometer 18 to calculate inclination, which is used to estimate user output power. The rotary encoder 23 detects and relays the exact position of the gear selector (see below) so that the current transmission ratio is known at all times.

The embodiment of FIG. 1B also uses the accelerometer 18 to calculate inclination which is used to estimate user output power. The pedal speed sensor 24 which, when combined with the rear hub speed sensor 26, allows a transmission ratio to be calculated at all times.

The embodiment of FIG. 1C is similar to the embodiment of FIG. 1A except the pedal force sensor 32 is used in place of the accelerometer 18 so that user power can be more directly calculated.

The embodiment of FIG. 1D is similar to the embodiment of FIG. 1B except the pedal force sensor 32 is used in place of the accelerometer 18 so that user power can be more directly calculated.

### INDUSTRIAL APPLICABILITY

In all cases, the controller 16 uses the current gear ratio and user output information in the same manner within the shift algorithm herein described.

In any embodiment, the controller 16 contains an algorithm (see below) that determines a user's effort level and then, through control of the transmission 20, matches a desired effort level with its corresponding gear ratio.

In one embodiment, the controller 16 itself is composed of a microchip, motor control hardware, volatile and non-volatile storage, printed circuit board, and integrated connectors (not shown) for interfacing with the external elements of the system 10. The algorithm works by first conditioning the various input signals, then once those signals are verified as legitimate and not induced by hardware noise, it begins a series of calculations.

While the process for determining the user's effort level can vary, the process of using user's effort to determine the optimum gear ratio is the basis of this invention. A few specific embodiments will be discussed, but they are not all-inclusive nor meant to limit the scope of this invention. The first method involves measuring the user's pedal force directly. One way to do this is through a force-sensing resistor combined with a voltage divider to determine the actual pedal force. Pedal force combined with crank arm information and pedal speed (or rear hub speed divided by a known transmission ratio) is an effective means for determining the user's speed and torque. Another method for estimating the user's effort is by measuring vehicle speed, deriving or measuring inclination, and either measuring pedal speed or using a known transmission ratio to derive pedal speed. These indirect approaches are much easier to package on a standard bicycle while still enabling the controller to have relatively accurate measures of user effort.

The first calculation in the indirect method is to determine the rear hub rate of acceleration. This is done by taking the derivative of the hub speed:

$$a = \frac{d v}{d t}$$

The next step is to derive the user's inclination using the accelerometer 18 in combination with the rear hub rate of acceleration. By converting a 0-5 volt signal, an absolute acceleration value, which is composed of two parts, can be obtained. The two parts are then broken down into the respective incline and bicycle acceleration components by applying the laws of similar triangles. As shown in FIG. 2A, a bicycle is traversing a path that is at an angle theta to the ground. Because conventional accelerometers only measure accelerations relative to Earth's gravitational pull which is always straight down, the sensor by itself is unable to distinguish the difference between simply accelerating on flat ground and having zero acceleration while moving on an incline. Any combination of the two factors, bicycle acceleration and incline, would also be indistinguishable from one another so long as the sum of the two portions was the same. In order to understand the user's actual operating environment, the system must know the bicycle acceleration by itself so that it can calculate the incline by subtracting the bicycle acceleration from the total acceleration.

The first part is the acceleration of the bike, based on the change in speed, which was determined above. The second part is the portion that is induced by the incline that the user is traversing. For example, the accelerometer outputs 0.05 g's and the change of rear hub speed portion calculates to 0.02 g's. That means 0.03 g's of the 0.05 total g's is from the inclination. Using a conversion from g-level to incline, we are able to determine that the user is accelerating 0.02 g's up an approximately 3% incline.

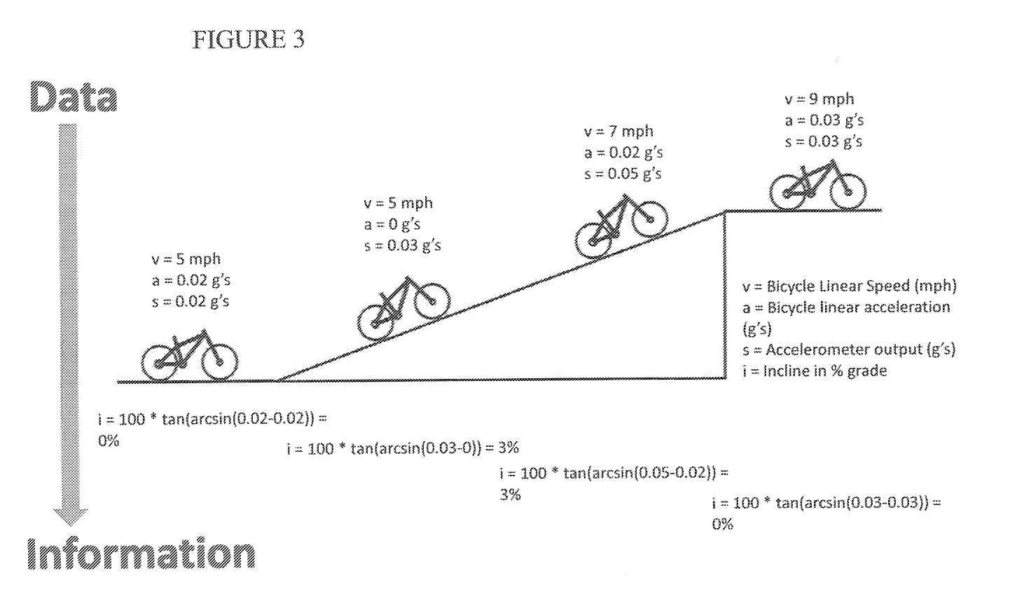

FIG. 3 is an example of how sensor output and calculated rate of acceleration can be used to determine inclination.

Once the above parameters are either measured or calculated, the entire operating condition of the vehicle 12 is known. The next step is to calculate a power output based on these conditions. The generic calculation for user output power on a human-powered vehicle is as follows:

P=gmV_{g}(K₁+s)+K₂×Vₐ²V_{g}

### Where:

### P=Power in Watts

g=Earth's gravity in m̂2/sec
Vg=Vehicle speed in msec
K1=Constant for frictional losses
K2=Constant for aerodynamic drag

Since the algorithm compares relative user output powers, it is not important to determine a mechanical efficiency of the vehicle 12. This simplifies the system 10 by allowing it to use vehicle power output directly in the next step of the algorithm.

User output power is composed of two parts, pedal cadence and pedal torque. Despite the current state of the art systems that target pedal cadence as the correct measurement for determining an optimum gear ratio, studies on the human body actually suggest that the desired pedal cadence in fact varies with the user's output power, which is composed of their pedal speed (cadence) and just as importantly, their output torque (effort). Because the system 10 of the present invention takes into account both factors, it is better able to assign the appropriate gear ratio for the specific operating environment that the user is experiencing, which leads to a more comfortable experience. Research and user feedback has helped define an equation that ties user output power to a desired pedal cadence to maximize comfort in any given operating condition. The equation is visually represented in FIG. 4 and can be found in generic form below:

NP=X1*P+X2

### Where:

### NP=Preferred Pedal Cadence in rpm

X1=Slope Constant (gain) in rpm/W

### P=Output Power in W

X2=Intercept Constant (offset) in rpm

Based on the user's preferences, the user is able to change the gain and/or offset of the above equation so that the system better matches his or her preferred operating style.

With a preferred pedal cadence calculated, the next step is to select a desired gear ratio based on the available ratios. Because every transmission system has minimum and maximum available ratios, an intermediate calculation must be performed to ensure that the desired gear ratio is actually able to be achieved on the given transmission system. This is accomplished by setting up a simple check so that any ratios below the minimum ratio are increased to the minimum ratio, and likewise any ratio above the maximum ratio are reduced to the maximum ratio. For continuously variable transmissions (CVTs), the next step is not required.

For non-CVT transmissions, the closest ratio to the desired ratio is selected by performing a simple equation as follows:

$$\vert DGR - R 1 \vert = Y 1$$

$$\vert DGR - R 2 \vert = Y 2$$

$$…$$

$$\vert DGR - RN \vert = YN$$

The smallest value of YN determines what ratio will be selected.

With the desired gear ratio determined, the control system 10 must now physically move the transmission gear selection components so that the desired ratio is achieved. Depending on the transmission system, a variety of methods can be employed to ensure that the ratio change has been completed successfully. One method is by constantly calculating the effective gear ratio between the pedal speed (cadence) and the rear hub speed. Knowing these two values in addition to any fixed gear reductions in between, the transmission ratio can be determined. A second method is to use an encoder to provide position feedback on the transmission shifting system itself. This eliminates the requirement of a pedal speed sensor 24.

FIG. 5 demonstrates one embodiment of the system 10 in which the controller 16 is mounted to a frame 52 in the area below the seat area and above the crank set 28. Depending on the vehicle configuration, the components of the system 10 could be mounted in a variety of other locations without changing the utility of this invention. In one embodiment, the system 10 shares its mount with a bi-directional electric motor 54 that acts as the shift actuator.

With respect to FIG. 6, the pedal speed sensing system 56 is designed to detect the speed of the pedal crank by using a fixed sensing element 58 to count the number of times a rotating object passes by in a known amount of time. This can be accomplished in a variety of fashions. One common approach is to mount a magnet or plurality of magnets 58A to the rotating element of the crank assembly 60 and then mount a sensing element 62 on a nearby fixed element. This is shown in FIG. 6.

A variation of FIG. 6 positions the sensing element 62′ perpendicular to the rotating element of the crank assembly 60 instead of planar and is shown in FIG. 7.

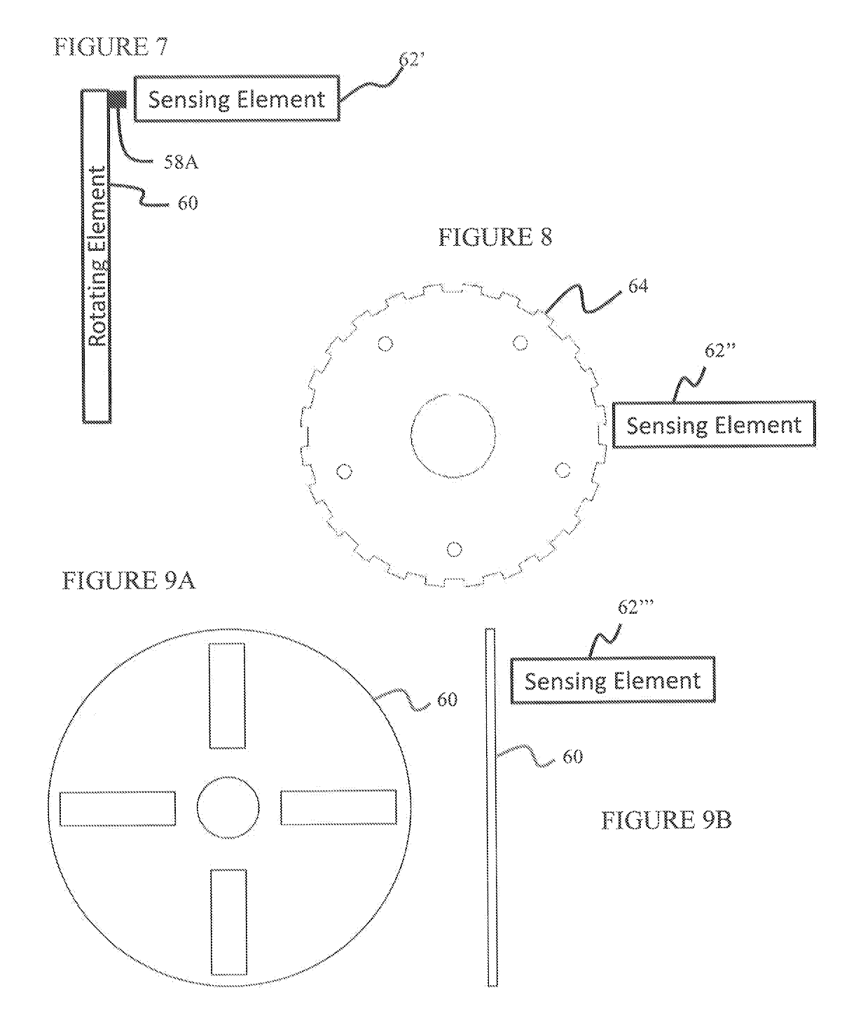

Another method is to mount a toothed wheel 64 made out of a magnetic material like steel with a plurality of teeth machined into it onto the pedal crank gear 60 with a sensing element 62″, typically a hall-effect device, fixed in a nearby position. This is shown in FIG. 8.

A variation of FIG. 8 positions the sensing element 62′″ perpendicular to the rotating element and this is shown in FIGS. 9A and 9B. In addition, this hall-effect device can have the ability to detect not only the speed of the rotating element, but also the direction in which it is rotating. The number of teeth, spacing of these teeth, and distance between the teeth and the sensing device are important factors because they collectively determine the resolution of the speed input along with the reliability of the signal.

The rear hub speed sensing system is designed to detect the speed of the rear hub by using a fixed sensing element to count the number of times a rotating object passes by in a known amount of time. This can be accomplished in a variety of fashions, such as any of the method shown in FIGS. 6-9B.

The battery 66, which represents an example of a power source, can be one of many different chemical compositions including lead acid, nickel metal hydride, lithium-ion, nickel cadmium, lithium ion polymer, and many others. The size and cost will determine which chemistry to choose but the key is that it's located as close to the microcontroller as feasible to reduce voltage drop to the bi-directional motor. It can be mounted in a storage rack, below the upper frame rail near the seat interface, or offset from the pedal crank assembly either above or below the frame rail. It could also be mounted in a variety of other locations without changing the utility of this invention.

A recharging element 68 to provide energy back to the battery pack 66 is a key component of the system 10. Potential recharging methods include an AC power adapter that plugs into a standard wall outlet, a front hub dynamo, a solar power generator, or a wind power generator. The source of power regenerations is only limited by the voltage and Wattage requirements of the controls system.

A display 68 may be mounted to the frame or handlebars 52 and relays important data from the controller 16 to the user and also provides a basic interface for inputting changes to the control limits that are user configurable 70. The data could be crank speed/cadence, rear hub speed, power output, inclination, acceleration, time, distance traveled, temperature, and torque. The display can also include key health/wellness metrics such as calories burned, heart rate, and others. The display 68 can of many types including liquid crystal display (LCD), thin-film transistor liquid crystal display (TFT-LCD), light-emitting diode display (LED), and many others.

Other aspect and features of the present invention can be obtained from a study of the drawings and the disclosure.

What is claimed is:

1. A system for controlling a transmission of a human-powered vehicle, the vehicle having an axle and a transmission with a plurality of gear ratios for transmitting force applied by a user to the axle, comprising:
a sensing device for measuring at least one parameter of the vehicle and generating a sensor signal;
a controller for receiving the sensor signal, responsively establishing an estimate of user effort as a function of the sensor signal, responsively establishing a desired gear ratio as a function of the estimate of the user effort, and sending a desired gear ratio signal to the transmission as a function of the established desired gear ratio.

2. A system, as set forth in claim 1, the sensing device including an accelerometer for measuring an acceleration associated with the vehicle.

3. A system, as set forth in claim 2, the controller for determining an inclination of the vehicle as a function measured acceleration.

4. A system, as set forth in claim 3, the sensing device including a gear ratio detector for detecting a current gear ratio of the transmission and generating a current gear ratio signal.

5. A system, as set forth in claim 4, the gear ratio detector including a rotary encoder coupled to the transmission.

6. A system, as set forth in claim 3, the sensing device include a pedal speed sensor and a rear hub speed sensor, the pedal speed sensor coupled to a crank set of the vehicle for sensing a pedal speed and responsively generating a pedal speed signal, the rear hub speed sensor coupled to the axle for sensing a rear hub axle speed and responsively generating a rear hub axle speed signal.

7. A system, as set forth in claim 6, wherein the controller receives the pedal speed signal and the rear hub axle speed signal and responsively determines a current gear ratio signal.

8. A system, as set forth in claim 4, the controller for receiving the current gear ratio signal and establishing the desired gear ratio as a function of the inclination of the vehicle and the current gear ratio signal.

9. A system, as set forth in claim 1, the sensing device includes a pedal force sensor coupled to a crank set of the vehicle for measuring a force applied to the crank set by the user and responsively generating a pedal force signal.

10. A system, as set forth in claim 9, the sensing device including a gear ratio detector for detecting a current gear ratio of the transmission and generating a current gear ratio signal.

11. A system, as set forth in claim 10, the gear ratio detector including a rotary encoder coupled to the transmission.

12. A system, as set forth in claim 9, the sensing device include pedal speed sensor and a rear hub speed sensor, the pedal speed sensor coupled to a crank set of the vehicle for sensing a pedal speed and responsively generating a pedal speed signal, the rear hub speed sensor coupled to the axle for sensing a rear hub axle speed and responsively generating a rear hub axle speed signal.

13. A system, as set forth in claim 12, wherein the controller receives the pedal speed signal and the rear hub axle speed signal and responsively determines a current gear ratio signal.

14. A system, as set forth in claim 10, the controller for receiving the current gear ratio signal and establishing the desired gear ratio as a function of the inclination of the vehicle and the current gear ratio signal.

15. A method for controlling a transmission of a human-powered vehicle, the vehicle having an axle and a transmission with a plurality of gear ratios for transmitting force applied by a user to the axle, including the steps of:
measuring at least one parameter of the vehicle and generating a first signal;
at a controller, receiving the sensor signal, responsively establishing an estimate of user effort as a function of the sensor signal, responsively establishing a desired gear ratio as a function of the estimate of the user effort, and sending a desired gear ratio signal to the transmission as a function of the established desired gear ratio.

16. A method, as set forth in claim 15, the at least one parameter being an acceleration associated with the vehicle.

17. A method, as set forth in claim 16, further comprising the step of determining an inclination of the vehicle as a function of measured acceleration.

18. A method, as set forth in claim 17, further including the step of detecting a current gear ratio of the transmission and generating a current gear ratio signal.

19. A method, as set forth in claim 18, the step of detecting a current gear ratio being performed by a rotary encoder coupled to the transmission.

20. A method, as set forth in claim 17, further including the steps of:
sensing a pedal speed of a crank set of the vehicle and responsively generating a pedal speed signal; and,
sensing a rear hub speed of the axle and responsively generating a rear hub axle speed signal.

21. A method, as set forth in claim 20, including the step of receiving, at the controller, receiving the pedal speed signal and the rear hub axle speed signal and responsively determining a current gear ratio signal.

22. A method, as set forth in claim 18, including the step of receiving, at the controller, the current gear ratio signal and establishing the desired gear ratio as a function of the inclination of the vehicle and the current gear ratio signal.

23. A method, as set forth in claim 15, including the step of measuring a force applied, by the user, to the crank set of the vehicle and responsively generating a pedal force signal.

24. A method, as set forth in claim 23, including the step of detecting a current gear ratio of the transmission and generating a current gear ratio signal.

25. A method, as set forth in claim 24, the step of detecting the current gear ratio being generated by a rotary encoder coupled to the transmission.

26. A method, as set forth in claim 23, the sensing device including a pedal speed sensor and a rear hub speed sensor, the pedal speed sensor coupled to a crank set of the vehicle for sensing a pedal speed and responsively generating a pedal speed signal, the rear hub speed sensor coupled to the axle for sensing a rear hub axle speed and responsively generating a rear hub axle speed signal.

27. A system, as set forth in claim 26, including the step of receiving the pedal speed signal and the rear hub axle speed signal and responsively determining a current gear ratio signal.

28. A system, as set forth in claim 24, including the step of receiving, at the controller, the current gear ratio signal and establishing the desired gear ratio as a function of the inclination of the vehicle and the current gear ratio signal.
